(19) United States
(12) Patent Application Publication
(10) Pub. No.: US 2012/0091724 A1
(43) Pub. Date: Apr. 19, 2012

(54) BRAKING SYSTEM OF A GENERATOR OF A WIND TURBINE

(75) Inventors: Klaus Bodenstein, Hong Kong S.A.R. (CN); Detlef Lange, Oberhausen (DE); Dieter Rupprich, Ohne (DE)

(73) Assignee: Avantis Ltd., Hong Kong (CN)

(21) Appl. No.: 13/264,378

(22) PCT Filed: Nov. 17, 2009
(86) PCT No.: PCT/EP2009/065304

§ 371 Date: Dec. 16, 2011

(30) Foreign Application Priority Data
Apr. 17, 2009 (DE) 1020090175318

(51) Int. Cl. H02K 7/102; F03D 9/00

(52) U.S. Cl. 290/55; 310/77

(57) ABSTRACT

The invention relates to a generator of a wind power station or a wind turbine comprising a stator (1) and a rotor (2) in addition to a disc brake. The aim of the invention is to provide a solution making it possible to provide a generator and a disc brake having a compact structure. Said aim is achieved in such a manner that the disc brake is integrated into the generator, said disc brake comprising a brake disc (6) which is embodied on the inner side on the outer rotor (2) and brake blocks (7) which are embodied on the inner side on the stator (1).

The invention is directed to a generator of a wind power installation or wind turbine with a stator and a rotor and a disk brake.

In order to be able to stop, if desired, a generator which is located in the tower of a wind power installation or wind turbine and is driven by the wind rotor and therefore also to be able to stop the wind rotor provided with the rotor blades, the drive train is provided with a brake. In this case, it is also known for such a brake to be in the form of a disk brake. Thus, DE 103 92 908 B4 has disclosed a wind turbine which has a clutch with an integrated disk brake in its drive train, which emerges from the wind rotor provided with the rotor blades, between a gear mechanism and a generator. Such a design is also disclosed in DE 101 19 428 A1.

These designs have the disadvantage that, owing to the disk brake arranged in front of the generator, they have a physical length which goes beyond the amount required for the physical shape of the generator.

The invention is based on the object of providing a solution which makes it possible to realize a more compact design of the generator and disk brake.

In the case of a generator of the type mentioned at the outset, this object is achieved according to the invention by virtue of the fact that the disk brake is formed so as to be integrated in the generator. According to the invention, the disk brake is therefore integrated in the region and in the physical shape of the generator. Thus, now only the space required for the generator is needed in the tower of a wind power installation or wind turbine for forming the generator and the disk brake. In particular in the case of wind turbines or wind power installations which can function without a gear mechanism interposed, this results in a more compact physical shape, which also entails a corresponding reduction in the external dimensions of the tower housing.

A particularly expedient design of the disk brake can be achieved in this case by virtue of the fact that the brake disk of the disk brake is formed on the inside in the rotor. Such a brake disk can surround the hub of the rotor, for example in the form of a circular ring, with the brake disk then being operatively connected to brake frames or brake blocks formed on the stator so as to form the disk brake. The brake disk rotating with the rotor can be guided and braked without any problems in the brake frames or brake blocks and this results overall in a compact disk brake. Therefore, a further configuration of the invention provides that at least one, preferably a plurality of brake frame(s) or brake block(s) gripping the brake disk is/are arranged on the inside on the stator.

Given such a compact configuration of a disk brake comprising elements of the rotating rotor and the fixed stator, it is possible for a further function to be integrated in an advantageous manner in the disk brake and in this case in particular in the brake disk. The brake disk formed as part of the rotor can furthermore be used for grounding and lightning protection of the rotating part of the wind turbine if the brake disk at the same time acts as a slipring. In order to form a DC-isolated connection between the stationary stator and the rotating rotor of the wind turbine, a carbon brush can be provided as sliding contact. Therefore, a development of the invention is characterized by the fact that the brake disk is in the form of an electrically conductive slipring and is part of a DC-isolated connection between the stator and the rotor. In this case, it is furthermore advantageous according to the invention if at least one carbon brush, which grips the slipring and/or the brake disk in the form of a sliding contact, is arranged on the stator. This DC-isolated connection is used at the same time for protecting the main bearing of the generator from disruptive electrical continuity since it represents a low-pole bypass.

Since it is possible to brake and stop the generator and therefore also the wind rotor of the wind turbine or wind power installation, said wind rotor being connected to said generator and having the rotor blades, in a targeted manner with the aid of the disk brake, it is also desirable to also provide the possibility of locking the generator and the wind rotor in the braked position. Since a stationary generator means a likewise stationary wind rotor owing to the rigid connection to said wind rotor, in particular in the case of wind power installations and wind turbines without a gear mechanism, a further possibility according to the invention which likewise contributes to a compact physical shape of the tower housing consists in providing this locking mechanism in the generator as well. In an advantageous configuration and development of the invention, therefore, it is further proposed that locking segments, which are provided with preferably conical bores, are arranged on the rotor analogously with respect to the number and preferably with respect to the position of the wind rotor blades and can be brought into operative connection, in such a way as to lock the rotor, with a locking bolt which can preferably be actuated hydraulically, is preferably in the form of a truncated cone and is arranged on the stator. It is therefore easily possible to provide a locking bolt on the stator which is capable of moving in the axial direction of the generator and which engages in one of a plurality of bores formed in locking segments which are formed circumferentially within the rotor in the form of circular ring segments, in order to lock the generator.

In order to fix the rotor in a manner which prevents further relative movement of the rotor and the stator with respect to one another, the invention furthermore proposes that, depending on the position of the rotor, the locking bolt can be inserted in latching fashion into one of the bores of the locking segments.

It is particularly advantageous if the rotor is an external rotor which is equipped in particular with permanent magnets, since in this case the inner (in relation thereto) stator can be equipped very easily with the brake frames or brake blocks and the carbon brush.

Finally, the invention can be used in particular in the case of wind power installations or wind turbines without a gear mechanism, with the result that the invention further provides that the generator is part of a multi-pole synchronous generator or asynchronous generator, whose rotor, in particular external rotor, is connected to the wind rotor of the wind power installation or wind turbine without a gear mechanism interposed.

It goes without saying that the features mentioned above and yet to be explained below can be used either in the respectively cited combination or else in other combinations or individually. Thus, the slipring function of a disk arranged in the rotor can be realized with the aid of a carbon brush arranged on the stator, without the disk at the same time needing to be a brake disk which interacts with brake blocks or brake frames. It is likewise possible to provide the locking elements, i.e. the locking segments and the locking bolt, without at the same time needing to realize the slipring function and/or the disk brake. The aspects according to the invention of the disk brake, the slipring forming a DC-isolated connection and the locking system comprising the locking segments and the locking bolt can each be realized individually and without implementing one of the respective other two aspects of the invention, i.e. can be realized independently of one another on a generator of a wind power installation or wind turbine. The scope of the invention is only defined by the claims, however.

The invention will be explained by way of example in more detail below with reference to a drawing, in which:

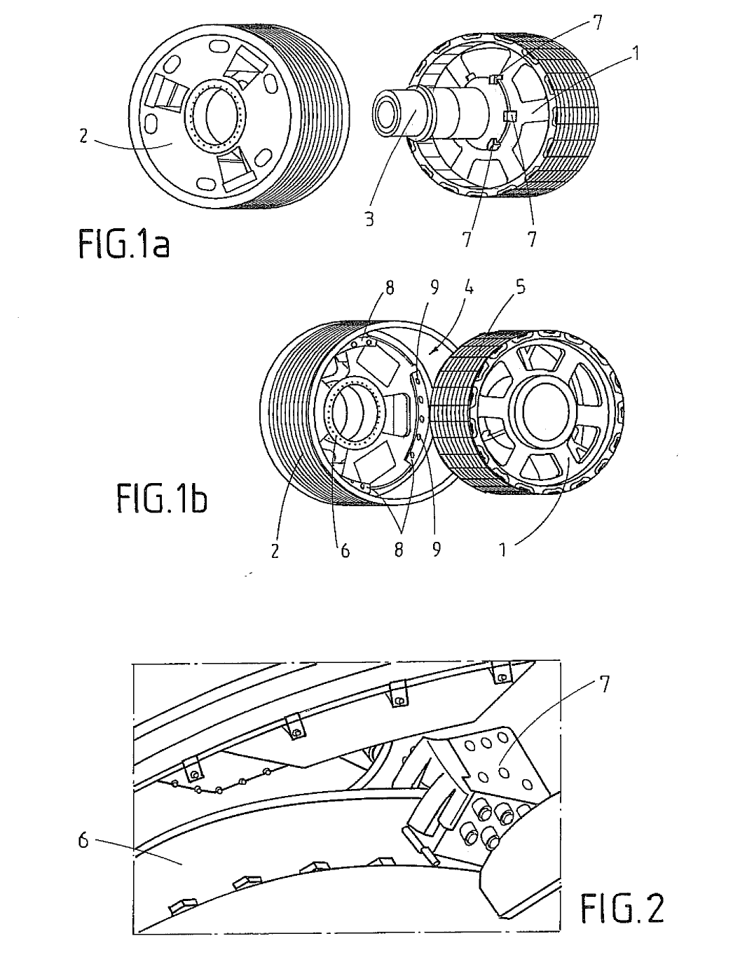

FIG. 1a shows a perspective illustration of an external view of a stator and an external rotor of a generator of a wind turbine,

FIG. 1b shows the stator and the external rotor in a perspective illustration in a view which is opposite to that in FIG. 1a,

FIG. 2 shows a perspective illustration of a detail of the brake disk with a brake block gripping said brake disk, and

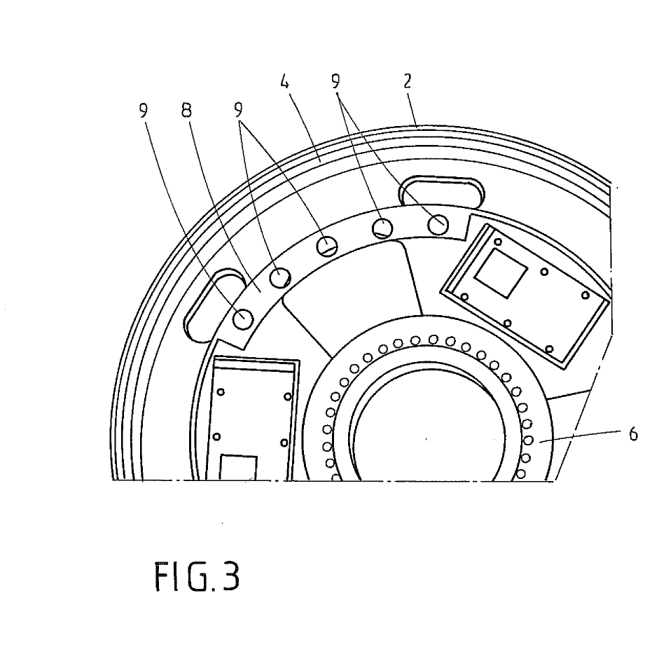

FIG. 3 shows a view onto a partial detail of the inner side of a rotor with a locking segment arranged therein.

FIGS. 1a and 1b show a stator 1, which, together with an external rotor 2, mounted on a common vertical shaft or so-called “king tube” 3, forms the generator of a wind turbine or wind power installation. The external rotor 2 has an inner ring 4 comprising permanent magnets on the inside, with the stator laminate stack 5 provided with windings being arranged opposite said inner ring. The generator comprising the stator 1 and the external rotor 2 forms a multi-pole asynchronous generator or synchronous generator which is driven by the wind rotor in the tower of a wind power installation or a wind turbine without a gear mechanism interposed.

A disk brake comprising a brake disk 6 and six brake frames or brake blocks 7 is integrated in the generator. The brake disk 6 is arranged in the form of a circular ring around the hub of the external rotor 2, said hub bearing the “king tube” 3, on the inside in the external rotor 2. In the assembled state of the stator 1 and the external rotor 2, the brake disk 6 is surrounded and gripped by the jaws of the brake blocks 7, as can be seen from FIG. 2. The brake blocks 7 are arranged on the inside on the stator 1, with the result that the brake disk 6 which is arranged on the inside in the external rotor 2 and the brake blocks which are arranged on the inside on the stator 1 are arranged in protected fashion facing one another on the inside in the generator. In this way, the disk brake thus formed is formed so as to be integrated in the generator.

The brake disk 6 is furthermore in the form of an electrically conductive slipring and is part of a DC-isolated connection between the stator 1 and the external rotor 2, with at least one carbon brush gripping the slipring and/or the brake disk 6 as a sliding contact being arranged on the stator 1 so as to form said DC-isolated connection, said carbon brush not being illustrated in any more detail in the figures.

Furthermore, three locking segments 8 are arranged and formed on the inside on a circular path which is spaced apart radially from the brake disk 6. The locking segments 8 in the form of a circular ring segment each have five conical bores 9, which can be brought into an operative connection, which locks the external rotor 2, with a locking bolt (not illustrated) which is arranged on the stator 1 and has an outer shape in the form of a truncated cone which corresponds to the conicity of the bores 9. For this purpose, the locking bolt (not illustrated) engages in one of the conical bores 9 and thus locks the external rotor 2 on the stator 1. Since the wind power installation or wind turbine is one without a gear mechanism, the wind rotor which rigidly to the external rotor 2 and rotates uniformly therewith and bears the rotor blades is therefore likewise locked. The external rotor 2 has a number of locking segments 8 corresponding to the number of rotor blades, said locking segments being spaced uniformly apart from one another corresponding to the spacing of the rotor blades. The locking segments 8 are thus arranged analogously to the number and to the position of the wind rotor blades on the external rotor 2.

The locking bolt is latched in the respective bore 9 into which it is inserted, which preferably takes place with the aid of a hydraulic drive.

The disk brake of the above-described generator serves to brake both the external rotor 2 and the wind rotor bearing the rotor blades which is operatively connected to the rotating external rotor 2. With the aid of the locking system comprising the locking segments 8 and the locking bolt, it is then possible for the wind rotor to be fixed in the same way as the external rotor 2, which is expedient in particular when performing maintenance and/or installation work in the tower of the wind turbine or wind power installation. Since the disk brake is also in the form of a slipring for a carbon brush forming a sliding contact, the grounding of the wind rotor and the rotor blades is thus ensured in the event of a lightning strike.

1. A generator of a wind power installation or wind turbine with a stator and a rotor and a disk brake, wherein the disk brake is formed so as to be integrated in the generator, wherein the brake disk is in the form of an electrically conductive slipring and is part of a DC-isolated connection between the stator and the rotor.

2. The generator as claimed in claim 1, wherein the brake disk of the disk brake is formed on the inside in the rotor.

3. The generator as claimed in claim 1, wherein at least one of brake frame(s) or brake block(s) gripping the brake disk is/are arranged on the inside on the stator.

4. The generator as claimed in claim 1, wherein at least one carbon brush, which grips the slipring and/or the brake disk in the form of a sliding contact, is arranged on the stator.

5. The generator as claimed in claim 1 wherein locking segments are arranged on the rotor analogously with respect to the number of the wind rotor blades and can be brought into operative connection, in such a way as to lock the rotor with a locking bolt.

6. The generator as claimed in claim 5, wherein depending on the position of the rotor, the locking bolt can be inserted in latching fashion into one of the bores of the locking segments.

7. The generator as claimed in claim 1, wherein the rotor is an external rotor.

8. The generator as claimed in claim 1, wherein the generator is part of a multi-pole synchronous generator or asynchronous generator, whose rotor is connected to the wind rotor of the wind power installation or wind turbine without a gear mechanism interposed.

9. The generator as claimed in claim 1, wherein a plurality of brake frame(s) or brake block(s) gripping the brake disk is/are arranged on the inside on the stator.

10. The generator as claimed in claim 5, wherein locking segments further comprise conical bores.

11. The generator as claimed in claim 5, wherein locking segments are further arranged on the rotor analogously with respect to the position of the wind rotor blades.

12. The generator as claimed in claim 5, wherein the locking bolt is hydraulically actuated.

13. The generator as claimed in claim 5, wherein locking segments are in the form of a truncated cone and are arranged on the stator.

14. The generator as claimed in claim 7, wherein the rotor is equipped with permanent magnets.

15. The generator as claimed in claim 8, wherein the rotor is an external rotor.
